(19) United States
(12) Patent Application Publication
(10) Pub. No.: US 2012/0124467 A1
(43) Pub. Date: May 17, 2012

(54) METHOD FOR AUTOMATICALLY GENERATING DESCRIPTIVE HEADINGS FOR A TEXT ELEMENT

(75) Inventor: Steven J. Harrington, Webster, NY (US)

(73) Assignee: Xerox Corporation, Norwalk, CT (US)

(21) Appl. No.: 12/946,366

(22) Filed: Nov. 15, 2010

(51) Int. Cl. G06F 17/24

(52) U.S. Cl. 715/256

(57) ABSTRACT

A method to automatically generate descriptive headings for each paragraph in a document analyzes each paragraph for keywords, identifies the clause in the paragraph that is most likely to contain the key ideas in the paragraph using the keywords previously identified. The subject predicate and object are extracted from the clause, and a heading is generated using the extracted subject, predicate, and object.

### BACKGROUND

A table-of-contents can be helpful when trying to understand the topics covered by a document or to locate a particular topic. However, a table-of-contents typically only describes topics to the section level.

To focus in on a particular topic, a concise description of the topics at a paragraph level (summarization of a paragraph) can be beneficial to the user of the document. On the other hand, the summarization of a paragraph may not be much more concise than the paragraph itself.

However, just providing a listing of keywords may not provide enough information to comprehend the topic(s) being discussed in the paragraph.

One solution to providing a vehicle to assist the user in understanding the topics covered by a document or to locate a particular topic is to require the author (generator of the document) to add paragraph headings as the document is being generated. However, this real-time documentation can time-consuming and be counter-productive to the normal process of document development.

Another solution to providing a vehicle to assist the user in understanding the topics covered by a document or to locate a particular topic is have someone review each paragraph of the document after a document has been completed to generate headings. This post-activity solution is also time consuming and reduces productivity.

Thus, it is desirable to provide a process of generating paragraph headings in an automated manner.

Furthermore, it is desirable to provide an automated process of generating paragraph headings such that the headings follow closely to the headings that a human would generate.

It is also desirable to provide an automated process of generating paragraph headings in a relatively rapid manner so that the overall process of generating headings is consistent with the desire to distribute a document once it has been generated.

Finally, it is desirable to provide an automated process, which is integrated into a document generation program, so that the headings could be generated on the fly as the document is developed, thereby allowing a person to review the headings as the headings are developed for the document and to modify or even eliminate headings as desired.

### BRIEF DESCRIPTION OF THE DRAWINGS

The drawings are only for purposes of illustrating various embodiments and are not to be construed as limiting, wherein:

FIG. 1 illustrates in flowchart form a method for automatically generating descriptive headings for a segment of text; and

FIG. 2 illustrates a system for automatically generating descriptive headings for a segment of text.

### DETAILED DESCRIPTION

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts could be properly illustrated.

A method for automatically generating descriptive headings for a text element is described below. For the sake of clarity of exposition, the description will describe adding headings to paragraphs in a document.

However, the described method is not limited to paragraphs, but can be implemented on any set of text elements for which a user would like to generate headings. The text elements could be paragraphs within a document, a whole document, or even a set of documents.

The described method may utilize a processor or an application specific integrated circuit (ASIC) to realize various techniques of computational linguistics and natural language processing.

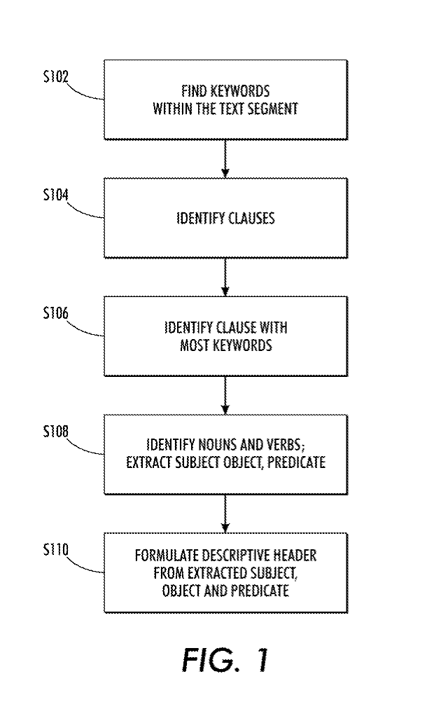

FIG. 1 illustrates an overview of a method to automatically create descriptive headings for a paragraph.

As illustrated in FIG. 1, in step S102, the paragraph is searched for keywords. Keywords are a set of words that have particular significance to the subject matter covered by the document of which the paragraph is an element.

The method may identify the keywords using several different conventional techniques. Such techniques for identifying keywords are conventional and well-known to those skilled in the art.

One such conventional technique may consider only nouns and verbs within the text. In this technique, using natural language processing facilities, parts of speech and the associated word(s) in the targeted text can be identified such that the nouns and verbs can be easily extracted.

In another conventional technique to identify keywords may utilize words that are found for the first time in the paragraph that is being analyzed. These “first-time” words often are illustrative of the new concepts that the text segment (paragraph) is describing. Thus, these “first-time” words are likely to be good candidates to include within a descriptive header for the targeted paragraph.

A modification of this “first-time” keyword identification technique would include a ranking as to how often the “first-time” words occur either within the targeted paragraph or within a larger context. For example, the technique may determine to how often a “first-time” word occurs within an entire document in which the targeted paragraph is included.

Another conventional technique to identify keywords may count a number of occurrences that a word is found within the targeted paragraph. The count of a word's occurrence can be divided by the count of the occurrence of the word within the larger document context. This larger context could be the document that the paragraph is part of or it could be some larger body of text. Alternatively, the word's occurrence can be divided by the count of documents in which the word appears within some set of documents. When the word occurs in the paragraph being analyzed and not elsewhere in the larger context, it is likely that the word is particularly characteristic of the targeted paragraph.

Alternatively, keywords can be identified by comparing the frequency of the words in the targeted paragraph to the frequency of the word within some standard large body of text.

In step S104 of FIG. 1, the clauses in the paragraph are identified. Various conventional techniques, which are well-known to those skilled in the art, can be utilized to identify clauses in text.

In one conventional technique, the paragraph is broken down into sentences by considering punctuation and capitalization. The words in each sentence are tagged according to the parts of speech. The sentences can be parsed against a pre-determined grammar to identify clauses.

An alternative method to identify clauses is to use a conventional technique called “chunking.”

Chunking looks for patterns in the parts of speech and groups individual words into phrases and clauses. By defining a set of grammar rules, chunks within the text of a paragraph may be identified. For example, simple grammatical rules can identify noun phrases within a text.

In step S106 of FIG. 1, each clause is analyzed to determine how many of the keywords are contained therein. The clause with the most keywords contained therein is selected.

The selected clause is most likely to contain the core ideas of the targeted paragraph.

When more than one clause contains the same number of keywords, the clause having the first position (first occurring in the targeted paragraph) in the targeted paragraph is chosen. Since important concepts are normally introduced early in a paragraph and then discussed in the subsequent sentences, it is more likely that the first occurring clause is likely to be more relevant than later occurring clauses with similar number of keywords.

Alternatively, a clause may be selected from the sentence that contains the most keywords, even if the keywords do not all occur within the clause.

In step S108 of FIG. 1, the selected clause is analyzed, using conventional techniques, to identify the subject, object, and predicate. Such conventional techniques for identifying grammatical elements are well-known to those skilled in the art. These grammatical elements are extracted from the selected clause.

In step S110 of FIG. 1, the nouns and verb are assembled into a brief descriptive heading.

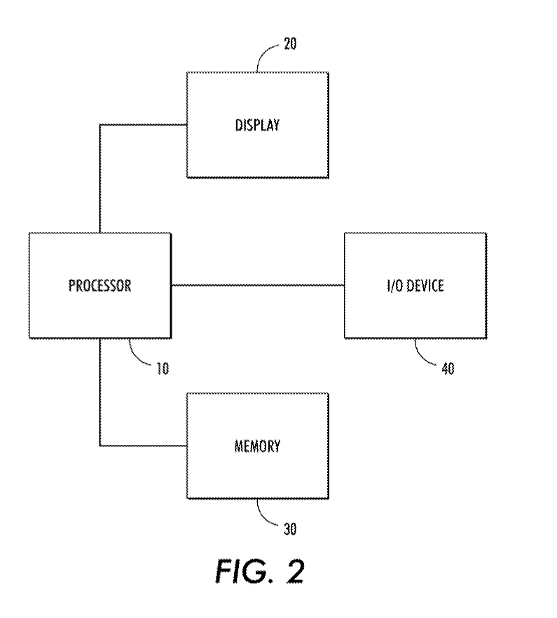

As illustrated in FIG. 2, a system for automatically generating descriptive headings for a text element includes a processor 10, an input/output device 40, a memory 30, and a display 20.

The processor 10 receives a text element. The text element may be received from memory 30 or from the input/output device 40. The processor 10 identifies keywords within a text element; separates the text element into clauses; selects the clause with a largest number of identified keywords in the text element; extracts the subject, predicate, and object from the selected clause; and generates a heading using the extracted subject, predicate, and object.

The display 20 may be utilized to show a user the results of the descriptive headings generation process.

An example of generating a brief descriptive heading will be discussed below using the paragraph shown in Example 1 below.

### Example 1

Most environmental health experts believe that the subtlest detectable effects—those with no outward symptoms, which are not clearly harmful—should be considered “precursors” of more serious effects. By this logic, people who show such subtle changes should be considered at risk for more serious effects if exposure continues.

Using a conventional technique, the identified (selected) keywords for the paragraph of Example 1 are “considered,” “risk,” “show,” and “subtlest.”

While these keywords may characterize the paragraph, these keywords do not immediately suggest what the paragraph is about.

Furthermore, the keywords are scattered throughout the paragraph. In addition, no clause contains more than one keyword.

In this case, the first clause containing a keyword may be selected. After identifying the subject, object, and predicate, the nouns “symptoms,” and “precursors” and the verb “considered” are identified. Combining these words, a descriptive heading, “symptoms considered precursors,” can be generated.

Another example of generating a brief descriptive heading will be discussed below using the paragraph shown in Example 2.

### Example 2

Skeletal fluorosis, a complicated illness caused by the accumulation of too much fluoride in the bones, has a number of stages. The first two stages are preclinical—that is, the patient feels no symptoms but changes have taken place in the body. In the first preclinical stage, biochemical abnormalities occur in the blood and in bone composition; in the second, histological changes can be observed in the bone in biopsies. Some experts call these changes harmful because they are precursors of more serious conditions. Others say they are harmless.

Using a conventional technique, the identified (selected) keywords for the paragraph of Example 2 are “preclinical,” “bone,” “illness,” “number.”

In this case, the first clause is selected for having the most number of keywords contained therein.

After identifying the subject, object, and predicate, the nouns “fluorosis” and “illness” are recognize. Moreover, a form of the verb “to be,” is implied. The constructed descriptive heading for the paragraph is then “fluorosis TO-BE illness.”

While the choice of “fluorosis has stages” may have been a better descriptive header, the clause containing that choice does not include any of the identified keywords.

The methods described above may be a stand-alone process that can accept a collection of text elements and generate descriptive headings for the text elements.

Alternatively, the methods described above may be implemented as part of a document processing program. In such an implementation, the method may, based upon a user selected option, automatically generate descriptive headings for the paragraphs in a document as the document is generated.

Another option may include the method as part of a document navigation package. In such a case, the method may generate the descriptive headings for text elements within the set of documents being navigated and assemble the generated headings into a table of contents.

In summary, a method for automatically producing descriptive headings for a collection of text elements may identify keywords within a text element; separate sentences and clauses within the sentences within the text element; select the clause with the largest number of identified keywords in the text element; extract the subject, predicate and object from the selected clause; and generate a heading using the extracted subject, predicate and object.

The collection of text elements might be a paragraph, a document, or a set of documents.

The method may select the clause that occurs first within the text element when more than one clause has same number of keywords; or select a clause from the sentence that contains the largest number of keywords.

The method may identify keywords by identifying words seen for the first time in the text element; identify keywords by counting the number of times a word appears within the text element; or identify keywords by counting the number of documents within a document corpus that contain the word.

The method may compare the count of a word in the text element with the count of the word in the whole document or may separate clauses within a text element by tagging the words in the text element according to the parts of speech.

The method may extract the subject, predicate and object from the selected clause by tagging the words in the clause according to the parts of speech or may identify clauses by a chunking procedure.

The method may include a document generation program to generate paragraph headings automatically as a document is generated by the document generation program.

The method may include a document navigation program to construct a table of contents as part of the document navigation program.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for automatically producing descriptive headings for a collection of text elements, comprising:
identifying keywords within a text element;
separating the text element into clauses;
selecting the most significant clause with respect to the identified keywords in the text element;
extracting the subject, predicate, and object from the selected clause; and
generating a heading using the extracted subject, predicate, and object.

2. The method as claimed in claim 1, wherein the most significant clause is the clause with the most keywords.

3. The method as claimed in claim 1, wherein the text element is a paragraph.

4. The method as claimed in claim 1, wherein the text element is a document.

5. The method as claimed in claim 1, wherein the text element is a set of documents.

6. The method as claimed in claim 1, further comprising:
selecting the clause that occurs first within the text element when more than one clause has a same number of keywords.

7. The method as claimed in claim 1, further comprising:
separating the text element into sentences;
selecting a clause from the sentence that contains the largest number of keywords.

8. The method as claimed in claim 1, further comprising:
identifying keywords by identifying words found for a first time in the text element.

9. The method as claimed in claim 1, further comprising:
identifying keywords by counting the number of times a word appears within the text element.

10. The method as claimed in claim 1, further comprising:
identifying keywords by counting the number of documents within a document corpus that contain a word.

11. The method as claimed in claim 1, further comprising:
comparing the count of a word in the text element with the count of the word in the whole document.

12. The method as claimed in claim 1, wherein the separating of clauses within a text element includes tagging the words in the text element according to parts of speech.

13. The method as claimed in claim 1, wherein the extracting the subject, predicate, and object from the selected clause includes tagging the words in the clause according to parts of speech.

14. The method as claimed in claim 1, further comprising:
identifying clauses by a chunking procedure.

15. The method as claimed in claim 1, further comprising:
generating paragraph headings automatically as a document is generated.

16. The method as claimed in claim 1, further comprising:
constructing a table of contents from the generated headings.
